(19) United States
(12) Patent Application Publication
(10) Pub. No.: US 2017/0030657 A1
(43) Pub. Date: Feb. 2, 2017

(54) METHOD OF MANUFACTURING TOTAL HEAT EXCHANGE ELEMENT, AND TOTAL HEAT EXCHANGER ELEMENT

(71) Applicant: Toray Industries, Inc., Tokyo (JP)

(72) Inventors: Taira OMORI, Otsu (JP); Tomomichi FUJIYAMA, Tokyo (JP); Hiroki TAKEDA, Otsu (JP); Katsuya SODE, Otsu (JP)

(21) Appl. No.: 15/106,458

(22) PCT Filed: Dec. 15, 2014
(86) PCT No.: PCT/JP2014/083121

§ 371 Date: Jun. 20, 2016

(30) Foreign Application Priority Data
Dec. 26, 2013 (JP) 2013-269047

(51) Int. Cl. F28D 21/00; C09K 5/14; B01J 20/04; B01J 20/28; B32B 29/08; D21H 27/40; B01D 53/26; B01D 53/28; B32B 3/28; B32B 29/00; F28F 3/02; B01J 20/32

(52) U.S. Cl. CPC F28D 21/0015; F28F 3/027; C09K 5/14; B01J 20/046; B01J 20/28035; B01J 20/3297; D21H 27/40; B01D 53/261; B01D 53/28; B32B 3/28; B32B 29/005; B32B 29/08; B01D 2253/112; F28F 2245/00; B32B 2419/00; B32B 2605/00; B32B 2457/00; B32B 2250/42; B32B 2262/02

(57) ABSTRACT

A method of manufacturing a total heat exchange element includes bonding a liner sheet and a corrugated sheet together to prepare a piece of single-faced corrugated cardboard and stacking plural pieces of the single-faced corrugated cardboard obtained in the previous step so that corrugated stripe directions of respective two adjacent pieces of single-faced corrugated cardboard are allowed to cross with each other, wherein a moisture absorbent is contained in at least a part of each of the liner sheet and the corrugated sheet, and R1 is 1 to 20 g/m² and R1/R2 is 0.5 to 2.0 when, before pieces of single-faced corrugated cardboard are stacked, the content of the moisture absorbent in the liner sheet and the content of the moisture absorbent in the corrugated sheet are defined as R1 and R2, respectively.

### TECHNICAL FIELD

This disclosure relates to a total heat exchange element used for a total heat exchanger mainly utilized in the field of air conditioning.

### BACKGROUND

A total heat exchanger has been attracting attention as an energy saving member for ventilating facilities of residential buildings and general buildings. A total heat exchanger is constituted of a total heat exchange element mainly performing total heat exchange and a blower that interchanges indoor air in a room and outside air. This total heat exchange element has a function of allowing the temperature and humidity of air to be exhausted from the inside of the room to the outside of the room to be translocated into air to be supplied from the outside of the room to the inside of the room and suppressing the variation in temperature and humidity in an indoor environment to be ventilated. Plural pieces of corrugated cardboard composed of a member (a liner sheet) allowing the temperature and humidity to be exchanged and a member (a corrugated sheet) forming passages through which air suction and air exhaustion are performed are stacked to form a total heat exchange element. The liner sheet is required to have heat transfer properties, water vapor transmission properties and air shielding properties for the purpose of enhancing the temperature exchange efficiency, the humidity exchange efficiency and the effective ventilation volume rate of the heat exchange element, and a technique to enhance the performance thereof has been studied.

For example, from the viewpoint of enhancing the water vapor transmission properties of a liner sheet, a total heat exchange element prepared with a liner sheet containing a water-soluble moisture absorbent such as lithium chloride has been disclosed (International Publication No. WO2002/099193).

Furthermore, a total heat exchange element in which a moisture absorbent is contained in a liner sheet and a water-insoluble adhesive is adopted as an adhesive used between a liner sheet and a corrugated sheet has been disclosed (International Publication No. WO2009/004695).

Moreover, a total heat exchange element which is a heat exchange element composed of a liner sheet and a corrugated sheet, allows moisture permeable films having gas shielding properties to be disposed on the surfaces of the liner sheet and the corrugated sheet respectively and allows a moisture permeable agent enabling latent heat to pass through the liner sheet and the corrugated sheet to be contained in the liner sheet and the corrugated sheet has been disclosed (Japanese Patent Laid-open Publication No. 2002-310589).

With regard to the heat exchange element disclosed in International Publication No. WO2002/099193 including a liner sheet containing a water-soluble moisture absorbent, there has been a problem that the humidity exchange efficiency is lowered with the lapse of time. It is thought that this is because the moisture absorbent is transferred from the liner sheet to another member, and in view of solving the problem, there have been disclosed total heat exchange elements in International Publication No. WO2009/004695 and Japanese Patent Laid-open Publication No. 2002-310589. With regard to the total heat exchange element described in International Publication No. WO2009/004695, there has been a problem that, from an early stage of use, the amount of moisture translocated at the time of being allowed to pass through the liner sheet is small. Moreover, as disclosed in Japanese Patent Laid-open Publication No. 2002-310589, even when a moisture absorbent is contained in both of the liner sheet and the corrugated sheet, there has been a tendency for the amount of moisture translocated to be lowered with the lapse of time.

Accordingly, it could be helpful to provide a total heat exchange element with which the humidity exchange efficiency is maintained also with the lapse of time.

### SUMMARY

We thus provide:

(1) A method of manufacturing a total heat exchange element containing a moisture absorbent including the steps of bonding a liner sheet and a corrugated sheet together to manufacture a piece of single-faced corrugated cardboard and stacking plural pieces of the single-faced corrugated cardboard obtained in the previous step so that corrugated stripe directions of respective two adjacent pieces of single-faced corrugated cardboard are allowed to cross with each other, wherein R1 is 1 to 20 g/m² and R1/R2 is 0.5 to 2.0 when the content of the moisture absorbent in the liner sheet before pieces of single-faced corrugated cardboard are stacked is defined as R1 and the content of the moisture absorbent in the corrugated sheet before pieces of single-faced corrugated cardboard are stacked is defined as R2.

Moreover, the following methods are exemplified.

(2) The method of manufacturing a total heat exchange element described above, wherein the content R1 is greater than R2.

(3) The method of manufacturing a total heat exchange element according to any one of methods described above, wherein R1/R2 is 1.3 to 2.0.

(4) The method of manufacturing a total heat exchange element according to any one of methods described above, wherein the moisture absorbent contains at least any one of an alkali metal salt and an alkaline earth metal salt.

(5) The method of manufacturing a total heat exchange element according to any one of methods described above, wherein the moisture absorbent is lithium chloride.

(6) The method of manufacturing a total heat exchange element according to any one of methods described above, wherein the moisture absorbent is potassium chloride.

(7) A total heat exchange element according to any one of total heat exchange elements described above, wherein the thickness of the corrugated sheet is 20 to 100 μm.

(8) The method of manufacturing a total heat exchange element according to any one of methods described above, wherein the liner sheet includes at least one layer of a gas shielding layer and one layer of a porous layer and the porous layer contains nanofibers of a thermoplastic resin.

And then, as a total heat exchange element manufactured by any one of methods mentioned above, the following total heat exchange element is exemplified.

(9) A total heat exchange element, being manufactured by the manufacturing method according to any one of methods described above, wherein the humidity exchange efficiency, which is measured under an air cooling condition by a method stipulated in JIS B8628 (2003), of the total heat exchange element is greater than or equal to 50%.

We thus provide a total heat exchange element high in heat exchange efficiency and allows the humidity exchange efficiency to be maintained also with the lapse of time.

### DETAILED DESCRIPTION

Hereinafter, the method of manufacturing a heat exchange element will be described. The method of manufacturing a total heat exchange element containing a moisture absorbent is a method of manufacturing a total heat exchange element including the steps of bonding a liner sheet and a corrugated sheet together to manufacture a piece of single-faced corrugated cardboard and stacking plural pieces of the single-faced corrugated cardboard obtained in the previous step so that corrugated stripe directions of respective two adjacent pieces of single-faced corrugated cardboard are allowed to cross with each other, wherein R1 is 1 to 20 g/m² and R1/R2 is 0.5 to 2.0 when, before pieces of single-faced corrugated cardboard are stacked, the content of the moisture absorbent in the liner sheet and the content of the moisture absorbent in the corrugated sheet are defined as R1 and R2, respectively. In the manufacturing method, a piece of single-faced corrugated cardboard is first manufactured. Usually, the following steps are executed. A corrugated sheet is shaped into a wave-shaped sheet by a pair of gear-shaped rolls engaged with each other to rotate. An adhesive is applied on flute-top portions of the corrugated sheet obtained, a liner sheet is pushed to flute-top portions of the corrugated sheet, and the liner sheet and the corrugated sheet are bonded together to obtain a single-faced corrugated cardboard sheet.

Next, plural pieces of the single-faced corrugated cardboard obtained are stacked so that corrugated stripe directions of respective two adjacent pieces of single-faced corrugated cardboard are allowed to cross with each other. Usually, the following steps are executed. An adhesive is applied on flute-top portions of the single-faced corrugated cardboard sheet obtained, and plural pieces of single-faced corrugated cardboard are stacked so that corrugated stripe directions which respective two adjacent pieces of single-faced corrugated cardboard have are allowed to cross with each other. And then, the pieces thereof are formed into a total heat exchange element with a desired size. In this connection, the corrugated stripe direction means a direction of the passage formed between the liner sheet and the corrugated sheet which are bonded together in the single-faced corrugated cardboard.

The total heat exchange element has a structure in which plural pieces of single-faced corrugated cardboard composed of a liner sheet and a corrugated sheet are stacked so that long-side directions of the passages of respective two adjacent pieces of single-faced corrugated cardboard are allowed to cross with each other. In the total heat exchange element, among passage directions allowed to cross with each other, supply air passes through the passage of one flow direction, and exhaust air passes through the passage of the other flow direction. In this case, heat exchange between the supply air and the exhaust air is performed mainly through the liner sheet. Thus, the higher the water vapor permeability of the liner sheet is, the more the total heat exchange element is also excellent in humidity exchange efficiency.

From the viewpoint of obtaining a total heat exchange element excellent in humidity exchange efficiency, the water vapor permeability under an environment of a temperature of 20° C. and a humidity of 65% RH (hereinafter, referred to as “the water vapor permeability 1”) of a liner sheet is preferably greater than or equal to 60 g/m²/hr, more preferably greater than or equal to 70 g/m²/hr, further preferably greater than or equal to 80 g/m²/hr and especially preferably greater than or equal to 90 g/m²/hr. Moreover, from the viewpoints of the enhancement in strength of a liner sheet and the enhancement in adhesive force between a liner sheet and a corrugated sheet, the water vapor permeability 1 of a liner sheet is preferably less than or equal to 200 g/m²/hr, more preferably less than or equal to 180 g/m²/hr and further preferably less than or equal to 150 g/m²/hr. In this connection, requirements such as the basis weight of a liner sheet, the density thereof, the content of a moisture absorbent contained in a liner sheet and the kind of the moisture absorbent can be appropriately combined to make the water vapor permeability 1 of a liner sheet lie within the above-mentioned range.

As the moisture absorbent, an alkali metal salt such as lithium chloride and an alkaline earth metal salt such as calcium chloride and magnesium chloride are preferred. Of these, lithium chloride and calcium chloride which have a high coefficient of water absorption are more preferred. Furthermore, lithium chloride which is capable of enhancing the humidity exchange efficiency with a smaller content thereof is most preferred. Separately, a urethane resin, polyoxyethylene, polyethylene glycol, a polyoxyalkylene alkyl ether, sodium polyacrylsulfonate and the like may be contained therein. Furthermore, a functional agent such as an antibacterial agent, a bacteriostatic agent and a flame retardant may be contained therein. Moreover, although the moisture absorbent contained in a liner sheet and the moisture absorbent contained in a corrugated sheet are not particularly specified, it is preferred that the moisture absorbents be the same as each other. By allowing the same moisture absorbent to be used for a liner sheet and a corrugated sheet, the transfer resistance at the time of moisture transfer can be suppressed at a portion of the total heat exchange element where total heat exchange is performed through the liner sheet and the corrugated sheet, and it is possible to obtain a total heat exchange element more excellent in humidity exchange efficiency.

The content of a moisture absorbent is defined as the mass of the moisture absorbent per 1 m² of a sheet. Moreover, in the content measurement, the content is defined as the mass determined by allowing the sheet to stand for 12 hours or more in a constant-temperature and constant-humidity chamber at a temperature of 23° C. and a relative humidity of 50% and, then, to be measured therefor.

The content of the moisture absorbent contained in a liner sheet before pieces of corrugated cardboard are stacked (R1) is RA 1 to 20 g/m². By allowing R1 to be greater than or equal to 1 g/m², the water vapor permeability of a liner sheet can be enhanced, and by using such a liner sheet, it is possible to obtain a total heat exchange element excellent in humidity exchange efficiency. From the viewpoint mentioned above, the lower limit of R1 is preferably greater than or equal to 2 g/m² and more preferably greater than or equal to 3 g/m². On the other hand, by allowing R1 to be less than or equal to 20 g/m², it is possible to suppress the lowering in strength of the liner sheet and the lowering in adhesive force between the liner sheet and the corrugated sheet, which are caused because the water vapor permeability of the liner sheet becomes too high and a large amount of moisture is contained in the liner sheet. From the viewpoint mentioned above, the upper limit of R1 is preferably less than or equal to 15 g/m² and more preferably less than or equal to 10 g/m². Moreover, when attention is paid to lithium chloride and calcium chloride which are preferably used as the moisture absorbent, in using potassium chloride, it is preferred that the content thereof lie within the above-mentioned range and, moreover, in using calcium chloride, it is preferred that the content thereof lie within the above-mentioned range. Moreover, in using potassium chloride and calcium chloride together, it is preferred that the sum of contents thereof lie within the above-mentioned range.

It is preferred that the liner sheet have a stacked structure including at least one layer of a porous layer.

The gas shielding layer does not need to have a nature of completely shielding gas. Provided that the gas shielding properties of a gas shielding layer is defined, it is preferred that a value defined as the carbon dioxide shielding rate shown in the column of EXAMPLES be greater than or equal to 35%. The carbon dioxide shielding rate is more preferably greater than or equal to 60% and further preferably greater than or equal to 70%. The gas shielding layer is preferably composed mainly of a fibrous substance. In this context, provided that allowing a fibrous substance to be “the main component” is defined, being composed mainly of a fibrous substance refers to allowing the amount of a fibrous substance contained in a gas shielding layer to be greater than 50% by mass when the amount of the gas shielding layer containing the fibrous substance is defined as 100% by mass. As the fibrous substance, fibers such as N pulp (softwood pulp), L pulp (hardwood pulp), bagasse, wheat straw, reeds, papyrus, bamboo, wood wool, kenaf, roselle, cannabis, flax, ramie, jute, hemp, Sisal hemp, Manila hemp, palm and banana are exemplified. Other examples include fibers composed of thermoplastic resins such as polyethylene terephthalate (PET), polytrimethylene terephthalate (PTT), polybutylene terephthalate (PBT), polylactic acid (PLA), polyethylene naphthalate (PEN), a liquid crystal polyester, nylon 6 (N6), nylon 66 (N66), nylon 11 (N11), nylon 12 (N12), polyethylene (PE), polypropylene (PP) and polystyrene (PS). Moreover, regenerated fibers (viscose rayon, cuprammonium rayon) and the like are also exemplified. These fibers may be used alone, but two or more kinds of fibers selected therefrom may be included. It is preferred that the gas shielding layer be composed mainly of a hydrophilic fibrous substance highly fibrillated because highly fibrillated fibers easily form a dense structural body that effectively shields the leakage of carbon dioxide from fiber clearances. Moreover, examples of the hydrophilic fibrous substance highly fibrillated include N pulp (softwood pulp), L pulp (hardwood pulp), aramid fibers, acrylic fibers and the like. Moreover, these fibers may be used alone, but two or more kinds of fibers selected therefrom may be included. Further preferably used is one constituted of cellulose pulp prepared by highly fibrillating N pulp (softwood pulp) and L pulp (hardwood pulp). By using cellulose pulp, papermaking properties are improved, and the gas shielding layer can be more firmly formed by the interaction attributed to hydrogen bonding between cellulose pulp fibers. Although the cellulose pulp is not particularly specified, N pulp (softwood pulp) and L pulp (hardwood pulp) obtained from plants such as wood and the like can be appropriately combined. These hydrophilic fibers capable of being fibrillated can be fibrillated by a beating machine such as a beater, a disc refiner, a deluxe finer, a jordan refiner, a grinder, a bead mill and a high-pressure homogenizer.

With regard to the upper limit of the beating degree of the fibrous substance used for the gas shielding layer, it is preferred that the beating degree thereof be less than 150 ml in the Canadian standard freeness test. The beating degree is more preferably less than or equal to 100 ml and further preferably less than or equal to 30 ml. With regard to the lower limit, it is preferred that the beating degree be greater than or equal to 10 ml. Such a fibrous substance is preferred because, by allowing the beating degree to be less than 150 ml, voids between fibrous substances in a gas shielding layer can be made fine by virtue of fibrillated fibrous substances, and whereby the gas shielding layer can be made into one that exerts high gas shielding properties. Moreover, by allowing the beating degree to be greater than or equal to 10 ml, voids between fibrous substances in a gas shielding layer can be sufficiently secured, and at the time of being made into a liner sheet, the water vapor transmission properties can be enhanced.

It is preferred that a liner sheet includes a porous layer. Provided that the porous layer is defined, at the time when a cross section thereof is observed, in a square region with a side of 100 μm, preferably there are 10 or more small holes with an area of a square with a side of 10 μm or an area smaller than that of the square, more preferably there are 10 or more small holes with an area of a square with a side of 3 μm or an area smaller than that of the square, and further preferably there are 50 or more small holes.

It is preferred that the porous layer be composed mainly of a fibrous substance.

Provided that allowing a fibrous substance to be the main component is defined, being composed mainly of a fibrous substance refers to allowing the amount of a fibrous substance contained in a porous layer to be greater than 50% by mass when the amount of the porous layer containing the fibrous substance is defined as 100% by mass. Examples of the fibrous substance include N pulp (softwood pulp), L pulp (hardwood pulp), bagasse, wheat straw, reeds, papyrus, bamboo, wood wool, kenaf, roselle, cannabis, flax, ramie, jute, hemp, Sisal hemp, Manila hemp, palm, banana, thermoplastic resin fibers (fibers composed of thermoplastic resins such as polyethylene terephthalate (PET), polytrimethylene terephthalate (PTT), polybutylene terephthalate (PBT), polylactic acid (PLA), polyethylene naphthalate (PEN), a liquid crystal polyester, nylon 6 (N6), nylon 66 (N66), nylon 11 (N11), nylon 12 (N12), polyethylene (PE), polypropylene (PP) and polystyrene (PS)), regenerated fibers (viscose rayon, cuprammonium rayon) and the like. These fibers may be used alone, but two or more kinds of fibers selected therefrom may be used. Of these, examples thereof preferably include cellulose pulp such as N pulp (softwood pulp) and L pulp (hardwood pulp) because the pulp is easily handled and is excellent in papermaking properties. These fibers can be moderately fibrillated by using a beating machine such as a beater, a disc refiner, a deluxe finer, a jordan refiner, a grinder, a bead mill and a high-pressure homogenizer.

With regard to the lower limit of the beating degree of the fibrous substance capable of being used for the porous layer, it is preferred that the beating degree thereof be greater than or equal to 150 ml in the Canadian standard freeness test. With regard to the upper limit, it is preferred that the beating degree be less than or equal to 700 ml. By allowing the beating degree to be greater than or equal to 150 ml, voids between fibrous substances can be sufficiently formed in a porous layer, and at the time of being made into a liner sheet, high water vapor transmission properties can be exerted. Moreover, by allowing the beating degree to be less than or equal to 700 ml, thin fibers are prepared and the uniformity of the sheet can be enhanced because the constituent fibers are sufficiently fibrillated.

More suitably, the porous layer contains nanofibers of a thermoplastic polymer as the fibrous substance preferably used for the porous layer.

The nanofiber means the fiber having a fiber diameter at a nanometer (nm) level, and specifically, refers to the fiber with a fiber diameter of greater than or equal to 1 nm and less than 1000 nm. In this connection, when the fiber cross section is a modified cross section, which is not a circular cross section, the fiber diameter is based on a fiber diameter calculated when the sectional shape is converted into a circular shape with the same area.

With regard to the upper limit of the fiber diameter of the nanofiber usable for a preferred example, from the viewpoint of capillary phenomenon acceleration, it is preferred that the fiber diameter thereof be less than or equal to 700 nm. The fiber diameter is more preferably less than or equal to 500 nm and further preferably less than or equal to 300 nm. With regard to the lower limit, in view of balance with productivity, it is preferred that the fiber diameter be greater than or equal to 1 nm. The fiber diameter is more preferably greater than or equal to 100 nm.

The nanofiber is composed of a thermoplastic polymer. Examples of the thermoplastic polymer include, with regard to the main component, a polyester, a polyamide, a polyolefin and the like. Examples of the polyester also include a liquid crystal polyester and the like, as well as polyethylene terephthalate (PET), polytrimethylene terephthalate (PTT), polybutylene terephthalate (PBT), polylactic acid (PLA), polyethylene naphthalate (PEN) and the like. Moreover, examples of the polyamide include nylon 6 (N6), nylon 66 (N66), nylon 11 (N11), nylon 12 (N12) and the like. Examples of the polyolefin include polyethylene (PE), polypropylene (PP), polystyrene (PS) and the like. Of these polymers, from the viewpoints of easily absorbing water and the affinity with cellulose pulp when the fibrous substance is cellulose pulp, a polyamide is preferred and nylon 6 is especially preferred. Moreover, it does not matter if a component other than the polyamide is allowed to undergo a copolymerization together with the thermoplastic polymer or is mixed therewith.

In this connection, for example, the nanofiber can be produced by a method described in JP-A-2005-299069 (paragraphs [0045] to [0057], paragraphs [0114] to [0117] and the like) or the like. Specifically, the method is as follows.

First, a production method of “polymer alloy fibers” as raw material to prepare nanofibers will be described. As the production method of polymer alloy fibers, for example, the following method can be adopted. That is, two or more kinds of polymers different from one another in solubility against a solvent or a chemical liquid are alloyed to prepare polymer alloy chips. The chips are charged into a hopper of a fiber spinning machine, made into an alloy melt in a melting section, discharged from a spinneret hole disposed at a spinneret pack in a heating or heat insulating spin block to be spun and, then, cooled and solidified by a chimney to be formed into a yarn thread. The yarn threads are allowed to pass through a collecting/oiling guide, a first haul-off roller and a second haul-off roller and wound with a winder to obtain a fiber. And then, this fiber is subjected to drawing or a heat treatment as necessary to obtain a polymer alloy fiber having a sea-island structure. Furthermore, this polymer alloy fiber is treated with a solvent or a chemical liquid and the sea component is removed to obtain a nanofiber used herein. In this context, the polymer alloy fiber has an island component composed of a polymer hardly-soluble in a solvent or a chemical liquid, which constitutes a nanofiber later on, and a sea component composed of a polymer readily-soluble therein, and by controlling the size of this island component, it is possible to design the single-fiber number average fiber diameter of nanofibers and the variation thereof. Since the diameter of a nanofiber is almost decided by the size of the island component in the polymer alloy fiber which is a nanofiber precursor, the size distribution of islands is designed depending on the fiber diameter distribution of a desired nanofiber. As such, kneading polymers to be alloyed is of great importance, and it is preferred that polymers be highly kneaded by a kneading extruder or a stationary kneading extruder.

By allowing a fibrous substance, which is not a nanofiber, and nanofibers of a thermoplastic polymer to be combined, a capillary structure with a structure in which voids between fibrous substances, which are not nanofibers, are densely filled with nanofibers is formed, and by virtue of the capillary phenomenon, it is possible to form a layer having high water vapor transmission properties. Furthermore, by allowing this porous layer to be stacked together with a gas shielding layer, the porous layer which is allowed to have a high surface area by virtue of nanofibers can easily absorb a larger amount of moisture. Moreover, since the nanofiber is composed of a thermoplastic polymer material, unlike cellulose, the strength is not largely lowered due to humectation, and the dimensional stability of a total heat exchange element, which is stable over a long period of time, can be maintained.

With regard to the lower limit of the content ratio of nanofibers in the porous layer, the content ratio is preferably greater than or equal to 5% by weight relative to the weight of a multilayer porous layer. The content ratio is more preferably greater than or equal to 30% by mass, and further preferably 50% by mass. On the other hand, with regard to the upper limit thereof, it is preferred that the content ratio lie within the range of less than or equal to 90% by mass. The content ratio thereof is more preferably 80% by mass. By allowing the content ratio to be greater than or equal to 5% by mass, it is possible to accelerate the capillary phenomenon and to obtain base paper for total heat exchange more excellent in water vapor transmission properties. On the other hand, by allowing the content ratio to be less than or equal to 90% by mass, the water-squeezability in a papermaking process is enhanced, and it is possible to enhance the productivity.

With regard to the lower limit of the basis weight of the gas shielding layer in a liner sheet, the basis weight is preferably greater than or equal to 15 g/m² and more preferably greater than or equal to 20 g/m². With regard to the upper limit thereof, the basis weight is preferably less than or equal to 50 g/m² and more preferably less than or equal to 40 g/m². By allowing the basis weight of the gas shielding layer to be greater than or equal to 15 g/m², it is possible to suppress irregularity of a sheet and to attain stable gas shielding properties. On the other hand, by allowing the basis weight to be less than or equal to 50 g/m², the thickness of a sheet can be made thin and it is possible to enhance the heat conductivity and water vapor transmission properties of a liner sheet.

On the other hand, with regard to the lower limit of the basis weight of the porous layer, the basis weight is preferably greater than or equal to 5 g/m² and more preferably greater than or equal to 10 g/m². With regard to the upper limit thereof, the basis weight is preferably less than or equal to 40 g/m² and more preferably less than or equal to 30 g/m². As in the case of the gas shielding layer described above, by allowing the basis weight to be greater than or equal to 5 g/m², it is possible to suppress irregularity from being generated in a sheet and to attain stable water vapor transmission properties. Moreover, by allowing the basis weight to be less than or equal to 40 g/m², the thickness of a sheet is thinned and it is possible to enhance the heat conductivity and water vapor transmission properties of a liner sheet.

In this connection, the basis weight of a liner sheet can be determined by adding up a basis weight of the gas shielding layer and a basis weight of the porous layer.

Although the production method of a liner sheet is not particularly specified, a method of separately preparing a gas shielding layer and a porous layer respectively and allowing the layers to be stacked and bonded together by an adhesive or heat may be adopted but is not preferred because the method causes a resin component in the adhesive to inhibit the transmission of heat or moisture as well as allows processes to become complicated. Preferred is a method of allowing a liner sheet to be formed by multilayer papermaking in papermaking technique. In that case, a desired stacked structural body can be obtained by appropriately preparing papermaking sections depending on the number of stacked layers and allowing the layers to be made into a sheet shape together. Moreover, as a papermaking machine, a cylinder paper machine having an arbitrary number of papermaking sections, a short wire cloth paper machine, a fourdrinier paper machine, a papermaking machine prepared by combining those machines, and the like can be used.

For the purpose of allowing a moisture absorbent to be contained in a liner sheet, the following methods are exemplified.

i) A dipping method of allowing a base material for a liner sheet to be immersed in a processing solution containing a moisture absorbent and, then, to be narrowed between a pair of rotating rolls.

ii) A coating method of applying a processing solution containing a moisture absorbent on the surface of a base material for a liner sheet.

iii) A spraying method of atomizing a processing solution containing a moisture absorbent onto the surface of a base material for a liner sheet to allow the moisture absorbent to stick thereto.

iv) A method of bonding a liner sheet and a corrugated sheet together to manufacture a piece of single-faced corrugated cardboard and, then, bringing a processing solution containing a moisture absorbent into contact with the surface of the liner sheet. As a method of bringing the processing solution into contact therewith, methods such as immersion, spraying and application are exemplified. In this method, at the same time, a moisture absorbent can be contained also in the corrugated sheet.

Among these, the dipping method is preferred because a moisture absorbent is allowed to infiltrate into the inside of the liner sheet and the moisture absorbent can serve as a moving medium for moisture absorbed in the liner sheet and accelerate the moving velocity of moisture.

Moreover, the liner sheet can also be processed with a functional agent such as a flame retardant, an antibacterial agent, a bacteriostatic agent and an antifungal agent, as necessary.

Next, a corrugated sheet, which is the other material constituting corrugated cardboard, will be described. In an adhesive portion between a corrugated sheet and a liner sheet of a total heat exchange element, since total heat exchange between the supply air and the exhaust air is performed through the corrugated sheet and the liner sheet, like the liner sheet, the higher the water vapor permeability of the corrugated sheet is, the more excellent in humidity exchange efficiency the total heat exchange element becomes.

From the viewpoint of obtaining a total heat exchange element excellent in humidity exchange efficiency, the water vapor permeability 1 of the corrugated sheet is preferably greater than or equal to 50 g/m²/hr, more preferably greater than or equal to 60 g/m²/hr and further preferably greater than or equal to 70 g/m²/hr. Moreover, from the viewpoint of enhancing the corrugated sheet strength and the adhesive force between the liner sheet and the corrugated sheet, the water vapor permeability 1 of the corrugated sheet is preferably less than or equal to 200 g/m²/hr, more preferably less than or equal to 180 g/m²/hr and further preferably less than or equal to 150 g/m²/hr. In this connection, the water vapor permeability 1 of a corrugated sheet can be adjusted depending on the basis weight of the corrugated sheet, the density thereof, the content of a moisture absorbent contained in the corrugated sheet, the kind of the moisture absorbent, and the like.

The content of a moisture absorbent in the corrugated sheet (R2) is 1 to 20 g per 1 m² of the corrugated sheet (that is, 1 to 20 g/m²). By allowing R2 to be greater than or equal to 1 g/m², the water vapor permeability of a corrugated sheet can be enhanced, and by using such a corrugated sheet, it is possible to obtain a total heat exchange element excellent in humidity exchange efficiency. From the viewpoint mentioned above, the lower limit of R2 is preferably greater than or equal to 2 g/m² and more preferably greater than or equal to 3 g/m². On the other hand, by allowing R2 to be less than or equal to 20 g/m², it is possible to suppress the lowering in strength of the liner sheet and the lowering in adhesive force between the liner sheet and the corrugated sheet, which are caused because the water vapor permeability of the liner sheet becomes too high and a large amount of moisture is contained in the liner sheet. From the viewpoint mentioned above, the upper limit of R2 is preferably less than or equal to 15 g/m² and more preferably less than or equal to 10 g/m².

Examples of the fibrous substance used for a corrugated sheet include ones described below. Fibers such as N pulp (softwood pulp), L pulp (hardwood pulp), bagasse, wheat straw, reeds, papyrus, bamboo, pulp, cotton, kenaf, roselle, cannabis, flax, ramie, jute, hemp, Sisal hemp, Manila hemp, palm and banana. Fibers composed of a thermoplastic resin such as polyethylene terephthalate (PET), polytrimethylene terephthalate (PTT), polybutylene terephthalate (PBT), polylactic acid (PLA), polyethylene naphthalate (PEN), a liquid crystal polyester, nylon 6 (N6), nylon 66 (N66), nylon 11 (N11), nylon 12 (N12), polyethylene (PE), polypropylene (PP) and polystyrene (PS). Regenerated fibers (viscose rayon, cuprammonium rayon), carbon fibers, metal fibers and glass fibers. These fibers may be used alone, but two or more kinds of fibers selected therefrom may be included. Furthermore, preferred are fibers capable of being fibrillated, and even among those, it is further preferred that pulp (N pulp, L pulp), which is excellent in affinity with water and is inexpensive, be used.

Moreover, as the corrugated sheet, fiber sheets such as fabric, knitted fabric and nonwoven fabric can be used, and even among those, a sheet of wet nonwoven fabric obtained by a papermaking method is preferred in view of the uniformity of the sheet and the porosity.

With regard to the lower limit of the thickness of the corrugated sheet, the thickness is preferably greater than or equal to 20 μm and more preferably greater than or equal to 30 μm. On the other hand, with regard to the upper limit thereof, the thickness is preferably less than or equal to 130 μm and more preferably less than or equal to 100 μm. By allowing the thickness of the corrugated sheet to be greater than or equal to 20 μm, the sheet strength of the corrugated sheet is enhanced, and it is possible to obtain a corrugated sheet excellent in handling properties at the time of being processed into a total heat exchange element. On the other hand, by allowing the thickness of the corrugated sheet to be less than or equal to 130 μm, the water vapor permeability of the corrugated sheet is enhanced, it is possible to obtain a total heat exchange element excellent in humidity exchange efficiency and it is possible to suppress the volume of the total heat exchange element small.

With regard to the lower limit of the basis weight of the corrugated sheet, the basis weight is preferably greater than or equal to 20 g/m², more preferably greater than or equal to 30 g/m² and especially preferably greater than or equal to 40 g/m². On the other hand, with regard to the upper limit thereof, the basis weight is preferably less than or equal to 150 g/m², more preferably less than or equal to 100 g/m² and especially preferably less than or equal to 80 g/m². By allowing the basis weight of the corrugated sheet to be greater than or equal to 20 g/m², the sheet strength of the corrugated sheet is enhanced, and it is possible to obtain a total heat exchange element excellent in dimensional stability. On the other hand, by allowing the basis weight of the corrugated sheet to be less than or equal to 150 g/m², the water vapor permeability of the corrugated sheet is enhanced, it is possible to obtain a total heat exchange element excellent in humidity exchange efficiency and it is possible to suppress the volume of the total heat exchange element small.

Although the production method of a corrugated sheet is not particularly specified, examples thereof include a method of preparing a base material for a corrugated sheet by a wet papermaking method or the like, allowing a moisture absorbent to be contained in the obtained base material for a corrugated sheet, and subjecting the base material for a corrugated sheet to corrugating processing, and the like. Examples of a method of allowing a moisture absorbent to be contained in a base material for a corrugated sheet include a dipping method of allowing a base material for a corrugated sheet to be immersed in a processing solution containing a moisture absorbent and then to be narrowed between a pair of rotating rolls, a coating method of applying a processing solution containing a moisture absorbent on the base material surface, a spraying method of atomizing the processing solution onto the base material to allow the moisture absorbent to stick thereto and the like. Of these, the dipping method is preferred because a moisture absorbent is allowed to infiltrate into the inside of the sheet and the moisture absorbent can serve as a moving medium for moisture absorbed in the sheet and accelerate the moving velocity of moisture. Moreover, the corrugated sheet can also be processed with a functional agent such as a flame retardant, an antibacterial agent, a bacteriostatic agent and an antifungal agent, as necessary.

As a means of allowing a moisture absorbent to be contained in a corrugated sheet, the following methods are exemplified.

i) A dipping method of allowing a base material for a corrugated sheet to be immersed in a processing solution containing a moisture absorbent and, then, to be narrowed between a pair of rotating rolls.

ii) A coating method of applying a processing solution containing a moisture absorbent on the surface of a base material for a corrugated sheet.

iii) A spraying method of atomizing a processing solution containing a moisture absorbent onto the surface of a base material for a liner sheet to allow the moisture absorbent to stick thereto.

iv) A method of bonding a liner sheet and a corrugated sheet together to manufacture a piece of single-faced corrugated cardboard and, then, bringing a processing solution containing a moisture absorbent into contact with the surface of the corrugated sheet. As a method of bringing the processing solution into contact therewith, methods such as immersion, spraying and application are exemplified. In this method, at the same time, a moisture absorbent can be contained also in the liner sheet.

The ratio (R1/R2) of the content of the moisture absorbent in the liner sheet before pieces of single-faced corrugated cardboard are stacked defined as R1 to the content of the moisture absorbent in the corrugated sheet before pieces of single-faced corrugated cardboard are stacked defined as R2 is 0.5 to 2.0. By allowing R1/R2 to be greater than or equal to 0.5, it is possible to suppress the amount of the moisture absorbent transferred from the corrugated sheet to the liner sheet, and it is possible to suppress the amount of the moisture absorbent that increases in the liner sheet from exceeding an upper limit of a desired range for the amount of the moisture absorbent contained in the liner sheet. From the viewpoint mentioned above, the lower limit of R1/R2 is preferably greater than or equal to 0.6, further preferably greater than or equal to 0.7 and still further preferably greater than 1.0. On the other hand, by allowing R1/R2 to be less than or equal to 2.0, it is possible to suppress the amount of the moisture absorbent transferred from the liner sheet to the corrugated sheet, and it is possible to suppress the amount of the moisture absorbent that decreases in the liner sheet from falling below a lower limit of a desired range for the amount of the moisture absorbent contained in the liner sheet. From the viewpoint mentioned above, the upper limit of R1/R2 is preferably less than or equal to 1.8 and further preferably less than or equal to 1.5.

As a method of allowing the value of R1/R2 to lie within a specific range at the time of manufacturing the total heat exchange element, the following methods are exemplified.

i) A method of allowing desired amounts of a moisture absorbent to be contained in a liner sheet and a corrugated sheet respectively, then, manufacturing a piece of single-faced corrugated cardboard and, then, manufacturing a total heat exchange element.

ii) A method of allowing a moisture absorbent to be contained in at least one kind of a liner sheet and a corrugated sheet, then, manufacturing a piece of single-faced corrugated cardboard, then, allowing a moisture absorbent to be contained in the piece of single-faced corrugated cardboard and, then, manufacturing a total heat exchange element.

iii) A method of manufacturing a piece of single-faced corrugated cardboard from a liner sheet and a corrugated sheet both of which do not allow a moisture absorbent to be contained therein, then, allowing a moisture absorbent to be contained in the piece of single-faced corrugated cardboard and, then, manufacturing a total heat exchange element.

In the above-mentioned manufacturing method ii and manufacturing method iii, at the time of allowing a moisture absorbent to be contained in the piece of single-faced corrugated cardboard, the liner sheet and the corrugated sheet can differ in the content of a moisture absorbent from each other. For example, there is a method of bringing a larger amount of a processing solution containing a moisture absorbent into contact with one face, to which a corrugated sheet is not bonded, of single-faced corrugated cardboard. Moreover, there is also a method of bringing a larger amount of a processing solution containing a moisture absorbent into contact with the other face, to which a corrugated sheet is bonded, thereof. Examples of the method of bringing a large amount of a processing solution into contact therewith include a method of allowing one face thereof to be treated, a method of allowing respective treatments for both faces thereof to differ in treatment time, and a method of allowing respective treatments for both faces thereof to differ in the spraying amount.

An adhesive used for adhesion between a liner sheet and a corrugated sheet at the time of preparing the total heat exchange element is not particularly specified. A preferred adhesive is an adhesive not inhibiting the movement of moisture that moves between the liner sheet and the corrugated sheet. In this context, examples of the adhesive include a starch-based adhesive, an ethylene-vinyl acetate emulsion-based adhesive, a vinyl acetate emulsion-based adhesive, a polyvinyl alcohol-based adhesive and the like.

It is preferred that the humidity exchange efficiency, measured under an air cooling condition described in the paragraph of the measurement method in EXAMPLES mentioned below, of the total heat exchange element be greater than or equal to 50%. By allowing the humidity exchange efficiency under an air cooling condition of the total heat exchange element to be greater than or equal to 50%, it is possible to obtain a total heat exchange element that exhibits high humidity exchange efficiency even in the summer season when a higher level of humidity exchange is required. From the viewpoint mentioned above, the lower limit of the humidity exchange efficiency under an air cooling condition of the total heat exchange element is more preferably greater than or equal to 70% and further preferably greater than or equal to 80%. Moreover, requirements such as the kind or the content of a moisture absorbent contained in a liner sheet and a corrugated sheet, the beating degree of a fibrous substance contained in a liner sheet, the basis weight of a liner sheet or a corrugated sheet, the thickness of a corrugated sheet, and allowing nanofibers to be contained in a liner sheet, or the content ratio of nanofibers contained in a liner sheet can be appropriately combined to enhance the humidity exchange efficiency under the air cooling condition of the total heat exchange element.

For example, the total heat exchange element can be utilized as various industrial members such as members for air conditioning, building materials, members for vehicles, members for ships and members for electric/electronic parts.

### EXAMPLES

Next, the heat exchange element will be described in detail with reference to examples.

### Measurement Methods

### (1) Beating Degree in Canadian Standard Freeness Test

The beating degree in the Canadian standard freeness test was measured in accordance with the JIS P8117 (1995) “Canadian Standard freeness testing method”.

### (2) Carbon Dioxide Shielding Rate

To an opening part (20 cm×20 cm) of a box with a width of 0.36 m, a length of 0.60 m and a height of 0.36 m (0.078 m³), a test specimen (25 cm×25 cm) was attached, carbon dioxide was injected so that the concentration thereof in the box becomes 8,000 ppm, and the carbon dioxide concentration (ppm) inside the box after 1 hour was measured to calculate the carbon dioxide shielding rate (%) by the following equation.

Carbon dioxide shielding rate (%)={(Carbon dioxide concentration inside box after 1 hour−Carbon dioxide concentration in outside air)/(Initial carbon dioxide concentration inside box−Carbon dioxide concentration in outside air)}×100

### (3) Water Vapor Permeability of Liner Sheet and Corrugated Sheet

The water vapor permeability was measured by a method of JIS Z0208 (1976) water vapor transmission rate (dish method). A cup used has a diameter φ of 60 mm and a depth of 25 mm. As test specimens for a liner sheet or a corrugated sheet, five circular pieces with a diameter φ of 70 mm were collected. The test specimens were dried for 1 hour with a dryer, the temperature of which was set to 80° C. and, then, subjected to a pretreatment for 1 hour in a constant-temperature and constant-humidity chamber, the temperature and humidity of which were set to 20° C. and 65% RH, respectively. Afterward, the test specimen was disposed in the cup containing calcium chloride for water content measurement (available from Wako Pure Chemical Industries, Ltd.), measured for the initial weight (T0), treated for 1, 2, 3, 4 or 5 hours in a constant-temperature and constant-humidity chamber, the temperature and humidity of which were set to 20° C. and 65% RH respectively, and measured for the weight after treated (T1, T2, T3, T4 or T5). The water vapor permeability was determined by the equation below, and an average value of five pieces was defined as the value.

Water vapor permeability (g/m²/hr)={[(T−T0)/T0)+((T−T1)/T1)+((T−T2)/T2)+((T−T3)/T3)+((T−T4)/T4)+((T−T5)/T5)]/5}×100

### (4) Air Permeability of Liner Sheet and Corrugated Sheet

The air permeability was measured by a method of JIS P8117 (1998) air permeability (Gurley tester method). As test specimens for a liner sheet or a corrugated sheet, five pieces with a length of 150 mm and a width of 150 mm were collected. The test specimens were treated for 1 hour in a constant-temperature and constant-humidity chamber, the temperature and humidity of which were set to 23° C. and 50% RH respectively. Under an environment of a temperature of 23° C. and a humidity of 50% RH, the test specimen was installed in a Gurley type densometer (model type G-B3C, Toyo Seiki Seisaku-sho, Ltd.), the time required for 100 ml of air to pass therethrough was measured, and an average value of five pieces was defined as the value (seconds/100 ml).

### (5) Thickness of Liner Sheet or Corrugated Sheet

With regard to the thickness, three pieces of the test specimen with a length of 200 mm and a width of 200 mm were collected from portions of a sample different from one another, allowed to stand for 24 hr at a temperature of 20° C. and a humidity of 65% RH and, then, measured for thicknesses (μm) of five points randomly selected from each piece of the test specimen with precision of 1 micron order using a measuring instrument (model type ID-112, available from Mitutoyo Corporation), and an average value thereof was defined as the value.

### (6) Basis Weight

With regard to the basis weight, three pieces of the test specimen with a length of 200 mm and a width of 250 mm were collected from portions of a sample different from one another, allowed to stand for 24 hours at a temperature of 20° C. and a humidity of 65% RH and, then, weighed for the weight (g) respectively, and an average value thereof was expressed in terms of weight per 1 m² (g/m²), and the average value of three pieces was defined as the value.

Moreover, the basis weight of a liner sheet was calculated by adding up basis weights of a gas shielding layer and a porous layer of the liner sheet. In this connection, with regard to the basis weights of a gas shielding layer and a porous layer in a liner sheet, respective layers of wet paper were removed from respective portions to be made into a sheet shape, after which the layers were dried and, then, measured in the same manner as above.

### (7) Number Average Fiber Diameter of Nanofiber

The number average fiber diameter of a nanofiber is determined as follows. That is, a photograph of an aggregate of nanofibers photographed at 30,000 magnifications by a scanning electron microscope (S-3500N type available from Hitachi, Ltd.) is prepared, and using image processing software (WINROOF), 30 single fibers chosen at random in a sample of 5 mm square are measured for the diameter with precision of the nm unit to the first decimal place, and the measured value is rounded off to the nearest integer. Sampling was performed 10 times in total, the diameter data of respective 30 single fibers were collected, the diameter data of 300 single fibers in total were integrated and, then, a simple average value obtained by dividing the integrated value by the total number was defined as the number average fiber diameter.

### (8) Temperature Exchange Efficiency and Humidity Exchange Efficiency of Heat Exchange Element

An air supply multiblade blower was attached to the downstream side of a passage for air supply of a heat exchange element and an air exhaust multiblade blower was attached to the downstream side of a passage for air exhaust of the heat exchange element to obtain a heat exchanger. Next, air to be introduced into a heat exchanger from the outside of a room (outside air), air to be introduced into the heat exchanger from the inside of the room (return air) and air to be supplied from the heat exchanger into the inside of the room (supply air) were measured for the temperature and humidity by a method specified in JIS B8628 (2003) to determine the temperature exchange efficiency and humidity exchange efficiency. In the measurement for the temperature and humidity, the temperature/humidity data logger (“ONDOTORI” (registered trademark) TR-71Ui available from T&D CORPORATION) was used. With regard to the location of the measurement for the temperature and humidity, the temperature and humidity were measured at a location apart from a heat exchange element by a distance of 30 cm. With regard to the air to be provided for the measurement, under the air cooling condition where the outside air is allowed to have a temperature of 35° C., a humidity of 64% RH and an air quantity of 150 m³/hr and the return air is allowed to have a temperature of 27° C., a humidity of 52% RH and an air quantity of 150 m³/hr, the humidity exchange efficiency was determined. Moreover, under the air heating condition where the outside air is allowed to have a temperature of 5° C., a humidity of 58% RH and an air quantity of 150 m³/hr and the return air is allowed to have a temperature of 20° C., a humidity of 51% RH and an air quantity of 150 m³/hr, the temperature exchange efficiency was determined.

### (9) Effective Ventilation Volume Rate of Heat Exchange Element

Air to be introduced into a heat exchanger from the inside of a room (return air) was allowed to have a carbon dioxide concentration of 8,000 ppm, and air to be introduced into the heat exchanger from the outside of the room (outside air) and air to be supplied from the heat exchanger into the inside of the room (supply air) were measured for the carbon dioxide concentration by a method specified in JIS B8628 (2003) to determine the effective ventilation volume rate by the equation below. In the measurement for the carbon dioxide concentration, a measuring instrument (“CO₂ measuring instrument testo 535” available from Testo AG) was used. With regard to the location of the measurement, the carbon dioxide concentration was measured at a location apart from a heat exchange element by a distance of 30 cm. With regard to the air to be provided for the measurement, the outside air was allowed to have a temperature of 20° C., a humidity of 50% RH and an air quantity of 150 m³/hr and the return air was allowed to have a temperature of 20° C., a humidity of 50% RH and an air quantity of 150 m³/hr.

Effective ventilation volume rate (%)=(Supply air-side carbon dioxide concentration−Outside air-side carbon dioxide concentration)/(Return air-side carbon dioxide concentration−Outside air-side carbon dioxide concentration)×100

(10) Temperature Exchange Efficiency and Humidity Exchange Efficiency of Heat Exchange Element after Lapse of Time

A treatment in which a heat exchange element is placed in a constant-temperature and high-humidity chamber, the temperature and humidity of which were adjusted to 40° C. and 90% RH respectively, for 168 hours and, then, placed in a thermostatic chamber, the temperature of which was adjusted to minus 30° C., for 168 hours was defined as 1 cycle, and at the end of 10 cycles, the heat exchange element was subjected to the measurement of (8) described above to determine the temperature exchange efficiency and humidity exchange efficiency.

### Example 1

### Preparation of Corrugated Sheet

A piece of bleached kraft paper with a thickness of 82 μm and a basis weight of 60 g/m² was treated by a dipping method with a processing solution prepared so that the content of lithium chloride as a moisture absorbent becomes 6.0 g/m² to allow the moisture absorbent to be contained therein.

The air permeability of a corrugated sheet obtained was determined to be 72 g/m²/hr. The characteristics are shown in Table 1.

### Fibers A for Liner Sheet

Softwood pulp was dispersed in water and beaten with a refiner so that the beating degree becomes 90 ml to obtain fibers A for a liner sheet. The fibers constitute fibers for a gas shielding layer.

### Fibers B for Liner Sheet

Moreover, softwood pulp was dispersed in water and beaten with a refiner so that the beating degree becomes 400 ml to obtain fibers B for a liner sheet. The fibers constitute fibers for a porous layer.

### Preparation of Liner Sheet

Using a cylinder paper machine which has two papermaking sections and enables two layers respectively composed of two kinds of fibers obtained as above to be stacked, the two kinds of fibers were prepared at the papermaking sections respectively to obtain a sheet with a basis weight of 40 g/m² composed of a layer made of fibers A for a liner sheet with a basis weight of 30 g/m² and a layer made of fibers B for a liner sheet with a basis weight of 10 g/m².

Afterward, the sheet was treated by a dipping method with a processing solution prepared so that the content of lithium chloride as a moisture absorbent becomes 6.8 g/m² to be added with the moisture absorbent.

The characteristics of the liner sheet obtained are shown in Table 1.

### Preparation of Total Heat Exchange Element

A corrugated sheet and a liner sheet mentioned above were bonded together to obtain a single-faced corrugated cardboard sheet with a height of flute of 2 mm and a pitch of flute of 5 mm. Afterward, plural pieces of single-faced corrugated cardboard sheets obtained promptly were stacked so that corrugated stripe directions of respective two adjacent pieces were allowed to cross with each other to prepare a total heat exchange element of 350 mm in longitudinal length by 350 mm in transversal length by 200 mm in height. At this time, the area of the corrugated sheet was 1.4 times the area of the liner sheet.

The characteristics of the total heat exchange element obtained are shown in Table 1.

### Example 2

### Preparation of Corrugated Sheet

A corrugated sheet was obtained in the same manner as that in Example 1.

### Preparation of Nanofibers

Using a twin screw type kneading extruder, 40% by weight of nylon 6 with a melting point of 220° C. and 60% by weight of poly-L-lactic acid with a melting point of 170° C. (optical purity of 99.5% or more) were melt-kneaded at 220° C. to obtain polymer alloy chips.

The above-mentioned polymer alloy chips were charged into a melt spinning machine for staple fiber provided with a single screw extruder, melted at 235° C. and led to a spin block. Then, a polymer alloy melt was filtered through metal nonwoven fabric with an ultrafiltration diameter of 15 μm, and discharged at a spinning temperature of 235° C. from a spinneret that has a discharge hole with a hole diameter of 0.3 mm and allows the temperature on a spinneret face to be set to 215° C. The discharged linear molten polymer was cooled and solidified by cooling air, imparted with an oil solution and withdrawn at a spinning speed of 1350 m/minute. The obtained undrawn yarns were doubled and, then, subjected to a draw heat treatment at a drawing temperature of 90° C., a draw ratio of 3.04 times and a thermosetting temperature of 130° C. to obtain tow of polymer alloy fibers with a single filament fineness of 3.0 dtex and a total fineness of five hundred thousand dtex. With regard to the obtained polymer alloy fiber, the strength was determined to be 3.4 cN/dtex and the elongation degree was determined to be 45%. The tow of the above-mentioned polymer alloy fibers was immersed for 1 hour in an aqueous 5% sodium hydroxide solution kept at 95° C. to hydrolyze and remove the poly-L-lactic acid component in the polymer alloy fiber. Then, the tow was neutralized with acetic acid, washed with water and dried to obtain a fiber bundle of nanofibers, and this fiber bundle was cut into a length of 1 mm. These cut fibers in a concentration of 30 g per 10 L of water were placed in a niagara beater for testing available from KUMAGAI RIKI KOGYO Co., Ltd. and preliminarily beaten for 5 minutes, and the water was drained to recover the fibers. Then, this recovery was placed in an automatic PFI mill (available from KUMAGAI RIKI KOGYO Co., Ltd.) and beaten for 6 minutes under the condition of a rotation number of 1500 rpm and a clearance of 0.2 mm. Then, the recovery formed in a clay-like form by containing water was dried for 24 hours in a hot air dryer at 80° C. to obtain nanofibers. The fiber diameter of the obtained nanofiber is 110 to 180 nm, and the number average fiber diameter was determined to be 150 nm.

### Fibers C for Liner Sheet

Into water, 60% by weight of the nylon 6 nanofiber with a number average fiber diameter of 150 nm obtained as above and 40% by weight of fibers B for a liner sheet obtained in Example 1 were charged and stirred to prepare mixed fibers and, thus, fibers C for a liner sheet were obtained. The fibers can constitute fibers for a porous layer.

### Preparation of Liner Sheet

Fibers A for a liner sheet of Example 1 and fibers B for a liner sheet obtained as above were used to prepare a liner sheet in the same manner as that in Example 1.

The characteristics of the liner sheet obtained are shown in Table 1.

### Preparation of Total Heat Exchange Element

A total heat exchange element was prepared in the same manner as that in Example 1 except that the above-mentioned corrugated sheet and liner sheet were used. The characteristics of the total heat exchange element obtained are shown in Table 1.

### Example 3

### Preparation of Corrugated Sheet

A corrugated sheet was obtained in the same manner as that in Example 1 except that a processing solution was prepared to allow the content of lithium chloride as a moisture absorbent to become 5.1 g/m².

### Preparation of Liner Sheet

A liner sheet was obtained in the same manner as that in Example 2. The characteristics of the liner sheet obtained are shown in Table 1.

### Preparation of Total Heat Exchange Element

A total heat exchange element was obtained in the same manner as that in Example 2. The characteristics of the total heat exchange element obtained are shown in Table 1.

### Example 4

### Preparation of Corrugated Sheet

A corrugated sheet was obtained in the same manner as that in Example 2 except that a processing solution was prepared to allow the content of lithium chloride as a moisture absorbent to become 4.2 g/m².

### Preparation of Liner Sheet

A liner sheet was obtained in the same manner as that in Example 2. The characteristics of the liner sheet obtained are shown in Table 1.

### Preparation of Total Heat Exchange Element

A total heat exchange element was obtained in the same manner as that in Example 2 except that the above-mentioned corrugated sheet and liner sheet were used. The characteristics of the total heat exchange element obtained are shown in Table 1.

### Example 5

### Preparation of Liner Sheet

Using a cylinder paper machine having two papermaking sections, fibers A for a liner sheet and fibers C for a liner sheet were prepared at the papermaking sections respectively to obtain a sheet with a total basis weight of 57 g/m² composed of a layer made of fibers A with a basis weight of 45 g/m² and a layer made of fibers C with a basis weight of 12 g/m².

Afterward, the sheet was treated by a dipping method with a processing solution prepared so that the content of lithium chloride as a moisture absorbent becomes 3.5 g/m² to be added with the moisture absorbent.

The characteristics of the liner sheet obtained are shown in Table 1.

### Preparation of Total Heat Exchange Element

A total heat exchange element was obtained in the same manner as that in Example 2. The characteristics of the heat exchange element obtained are shown in Table 1.

### Example 6

### Preparation of Corrugated Sheet

A corrugated sheet was obtained in the same manner as that in Example 4.

### Preparation of Liner Sheet

A liner sheet was obtained in the same manner as that in Example 2 except that the basis weight of a layer of fibers A and the basis weight of a layer of fibers C were set to 45 g/m² and 12 g/m², respectively and, furthermore, a processing solution was prepared to allow the content of lithium chloride as a moisture absorbent to become 8.0 g/m².

The characteristics of the liner sheet obtained are shown in Table 1.

### Preparation of Total Heat Exchange Element

A total heat exchange element was obtained in the same manner as that in Example 2 except that the above-mentioned liner sheet was used. The characteristics of the heat exchange element obtained are shown in Table 1.

### Comparative Example 1

A corrugated sheet, a liner sheet and a total heat exchange element were obtained in the same manner as that in Example 1 except that the addition of lithium chloride as a moisture absorbent was not performed in the preparation of the corrugated sheet. The characteristics thereof are shown in Table 2.

### Comparative Example 2

A corrugated sheet, a liner sheet and a total heat exchange element were obtained in the same manner as that in Example 2 except that a processing solution was prepared to allow the content of lithium chloride as a moisture absorbent for the corrugated sheet to become 0.3 g/m² in the preparation of the corrugated sheet. The characteristics thereof are shown in Table 2.

### Comparative Example 3

A corrugated sheet and a liner sheet were obtained in the same manner as that in Example 1 except that a processing solution was prepared to allow the content of lithium chloride as a moisture absorbent for the corrugated sheet to become 21.0 g/m² in the preparation of the corrugated sheet. With regard to a total heat exchange element, exfoliation between layers of a corrugated sheet and a liner sheet of single-faced corrugated cardboard occurred and a total heat exchange element failed to be obtained.

The characteristics thereof are shown in Table 2.

### Comparative Example 4

A corrugated sheet, a liner sheet and a total heat exchange element were obtained in the same manner as that in Example 6 except that a processing solution was prepared to allow the content of lithium chloride as a moisture absorbent for the corrugated sheet to become 3.5 g/m² in the preparation of the corrugated sheet. The characteristics thereof are shown in Table 2.

TABLE 1

| | | Example 1 | Example 2 | Example 3 | Example 4 | Example 5 | Example 6 |
|---|---|---|---|---|---|---|---|
| Liner | Moisture absorbent content | 6.8 | 6.8 | 6.8 | 6.8 | 3.5 | 8.0 |
| sheet | (g/m²) (R1) | | | | | | |
| | Thickness (μm) | 61 | 55 | 55 | 55 | 65 | 67 |
| | Air permeance (sec/100 ml) | 7500 | 3200 | 3200 | 3200 | 8000 | 7000 |
| | Water vapor permeability | 76 | 91 | 91 | 91 | 75 | 95 |
| | (g/m²/hr) | | | | | | |
| Corrugated | Moisture absorbent content | 6.0 | 6.0 | 5.1 | 4.2 | 6.0 | 4.2 |
| sheet | (g/m²) (R2) | | | | | | |
| | Thickness (μm) | 85 | 85 | 84 | 80 | 85 | 80 |
| | Air permeance (sec/100 ml) | 25 | 25 | 25 | 23 | 25 | 23 |
| | Water vapor permeability | 72 | 72 | 70 | 69 | 72 | 69 |
| | (g/m²/hr) | | | | | | |
| R1/R2 | | 1.13 | 1.13 | 1.33 | 1.62 | 0.58 | 1.90 |
| Effective ventilation volume rate (%) | | 96 | 95 | 96 | 97 | 95 | 96 |
| Temperature exchange efficiency (%) | | 84 | 85 | 86 | 83 | 80 | 88 |
| (Air heating condition) | | | | | | | |
| Humidity exchange efficiency (%) | | 74 | 75 | 80 | 73 | 72 | 80 |
| (Air cooling condition) | | | | | | | |
| Exchange | Temperature exchange | 82 | 83 | 85 | 80 | 78 | 86 |
| efficiency | efficiency (%) | | | | | | |
| after lapse | (Air heating condition) | | | | | | |
| of time | Humidity exchange | 70 | 71 | 80 | 70 | 70 | 78 |
| | efficiency (%) | | | | | | |
| | (Air cooling condition) | | | | | | |

TABLE 2

| | | Comparative | Comparative | Comparative | Comparative |
|---|---|---|---|---|---|
| | | Example 1 | Example 2 | Example 3 | Example 4 |
| Liner sheet | Moisture absorbent | 6.8 | 6.8 | 6.8 | 8.0 |
| | content | | | | |
| | (g/m²) (R1) | | | | |
| | Thickness | 61 | 55 | 61 | 67 |
| | (μm) | | | | |
| | Air permeance | 7500 | 3200 | 7500 | 7000 |
| | (sec/100 ml) | | | | |
| | Water vapor permeability | 76 | 91 | 76 | 95 |
| | (g/m²/hr) | | | | |
| Corrugated | Moisture absorbent | 0 | 0.3 | 21 | 3.5 |
| sheet | content | | | | |
| | (g/m²) (R2) | | | | |
| | Thickness | 83 | 83 | 86 | 79 |
| | (μm) | | | | |
| | Air permeance | 20 | 20 | 15 | 28 |
| | (sec/100 ml) | | | | |
| | Water vapor permeability | 43 | 45 | 220 | 65 |
| | (g/m²/hr) | | | | |
| R1/R2 | | — | 22.7 | 0.32 | 2.29 |
| Effective ventilation volume rate (%) | | 96 | 95 | — | 94 |
| Temperature exchange efficiency (%) | | 81 | 83 | — | 83 |
| (Air heating condition) | | | | | |
| Humidity exchange efficiency (%) | | 64 | 72 | — | 68 |
| (Air cooling condition) | | | | | |
| Exchange | Temperature exchange | 78 | 80 | — | 77 |
| efficiency | efficiency (%) | | | | |
| after lapse of | (Air heating condition) | | | | |
| time | Humidity exchange | 35 | 39 | — | 58 |
| | efficiency (%) | | | | |
| | (Air cooling condition) | | | | |

As shown in Tables 1 and 2, total heat exchange elements of Examples 1 to 6 are excellent in humidity exchange efficiency under the air cooling condition and are also excellent in humidity exchange efficiency under the air cooling condition after the lapse of time. On the other hand, total heat exchange elements of Comparative Examples 1, 2 and 4 are poor in humidity exchange efficiency under the air cooling condition as compared to those of Examples 1 to 6, but the total heat exchange elements of Comparative Examples 1, 2 and 4 have a certain level of performance. However, the humidity exchange efficiency under the air cooling condition after the lapse of time is significantly lowered. Moreover, with regard to Comparative Example 3, in the preparation of a total heat exchange element, there was much moisture absorption, warpage and undulation were generated in the single-faced corrugated cardboard sheet, poor bonding was caused, and a total heat exchange element failed to be obtained.

1.-9. (canceled)

10. A method of manufacturing a total heat exchange element containing a moisture absorbent, comprising:
bonding a liner sheet and a corrugated sheet together to manufacture a piece of single-faced corrugated cardboard; and
stacking plural pieces of the single-faced corrugated cardboard obtained so that corrugated stripe directions of respective two adjacent pieces of single-faced corrugated cardboard are allowed to cross with each other,
wherein R1 is 1 to 20 g/m² and R1/R2 is 0.5 to 2.0 when the content of the moisture absorbent in the liner sheet before pieces of single-faced corrugated cardboard are stacked is defined as R1 and the content of the moisture absorbent in the corrugated sheet before pieces of single-faced corrugated cardboard are stacked is defined as R2.

11. The method according to claim 10, wherein R1 is greater than R2.

12. The method according to claim 10, wherein R1/R2 is 1.3 to 2.0.

13. The method according to claim 10, wherein the moisture absorbent contains at least any one of an alkali metal salt and an alkaline earth metal salt.

14. The method according to claim 10, wherein the moisture absorbent is lithium chloride.

15. The method according to claim 10, wherein the moisture absorbent is potassium chloride.

16. The method according to claim 10, wherein the thickness of the corrugated sheet is 20 to 100 μm.

17. The method according to claim 10, wherein the liner sheet includes at least one layer of a gas shielding layer and one layer of a porous layer and the porous layer contains nanofibers of a thermoplastic resin.

18. The method according to claim 17, wherein R1/R2 is 1.3 to 2.0.

19. A total heat exchange element manufactured by the method according to claim 10, wherein the humidity exchange efficiency, which is measured under an air cooling condition by a method stipulated in JIS B8628 (2003), of the total heat exchange element is greater than or equal to 50%.
